(19) United States
(12) Patent Application Publication
(10) Pub. No.: US 2024/0382993 A1
(43) Pub. Date: Nov. 21, 2024

(54) CHEMICAL SUPPLY APPARATUS AND OPERATION METHOD OF THE SAME

(71) Applicant: INNOSCIENCE (SUZHOU) SEMICONDUCTOR CO., LTD., Jiangsu (CN)

(72) Inventor: Rui LIU, Suzhou City (CN)

(21) Appl. No.: 17/921,358

(22) PCT Filed: Jun. 28, 2022
(86) PCT No.: PCT/CN2022/102005

§ 371 Date: Oct. 26, 2022

(51) Int. Cl. B05B 12/32; F04B 43/12

(52) U.S. Cl. CPC B05B 12/32; F04B 43/12

(57) ABSTRACT

A chemical supply apparatus is provided. The chemical supply apparatus includes a protecting structure, a peristaltic pump, and a fluid pipe. The protecting structure has a first opening and a second opening, and the second opening is located above the first opening. The peristaltic pump is disposed on the protecting structure. The fluid pipe is disposed in the protecting structure and the peristaltic pump. The first opening and the second opening are facing towards the same direction. The fluid pipe connects the first opening and the second opening. The peristaltic pump is configured to control fluid in the fluid pipe. The protecting structure is adapted to cover an outlet of a chemical fluid container. An operation method of a chemical supply apparatus is also provided.

### FIELD OF THE INVENTION

The present invention generally relates to a supply apparatus. More specifically, the present invention relates to a chemical supply apparatus.

### BACKGROUND

In recent years, intense research on high-electron-mobility transistors (HEMTs) has been prevalent, particularly for high power switching and high frequency applications. III-nitride-based HEMTs utilize a heterojunction interface between two materials with different bandgaps to form a quantum well-like structure, which accommodates a two-dimensional electron gas (2DEG) region, satisfying demands of high power/frequency devices. In addition to HEMTs, examples of devices having heterostructures further include heterojunction bipolar transistors (HBT), heterojunction field effect transistor (HFET), and modulation-doped FETs (MODFET).

During the manufacturing process, metal ions are needed. Now, metal ions fluid with high purity can be manufactured and packaged in barrels, and operators may transfer the fluid with transferring device, such as dropper, pipette, or siphon. However, the fluid may be polluted during the transferring process, and impurity of the metal ions may affect the electric properties of the chip containing HEMTs. Also, if the operators directly touch the pipes or the tubes of the transferring device or the opening of the barrel, the fluid may be polluted as well. Therefore, a transferring device which is portable and having unpolluted transferring tubes or pipes is needed.

### SUMMARY OF THE INVENTION

In accordance with one aspect of the present disclosure, a chemical supply apparatus is provided. The chemical supply apparatus includes a protecting structure, a peristaltic pump, and a fluid pipe. The protecting structure has a first opening and a second opening, and the second opening is located above the first opening. The peristaltic pump is disposed on the protecting structure. The fluid pipe is disposed in the protecting structure and the peristaltic pump. The first opening and the second opening are facing towards the same direction. The fluid pipe connects the first opening and the second opening. The peristaltic pump is configured to control fluid in the fluid pipe. The protecting structure is adapted to cover an outlet of a chemical fluid container.

In accordance with one aspect of the present disclosure, method for operating a chemical supply apparatus is provided. The method includes steps as follows. Disposing the chemical supply apparatus on a chemical fluid container; extending part of a fluid pipe from a protecting structure of the chemical supply apparatus to the inside of the chemical fluid container through an outlet of the chemical fluid container; and turn on a peristaltic pump being installed to the fluid pipe. The chemical supply apparatus covers the outlet of the chemical fluid container. The chemical supply apparatus includes the protecting structure, the fluid pipe, and the peristaltic pump. The peristaltic pump is disposed on the protecting structure. The fluid pipe is disposed in the protecting structure and the peristaltic pump. A second opening of the protecting structure is located above a first opening of the protecting structure. The first opening and the second opening are facing towards the same direction. The fluid pipe connects the first opening and the second opening. The peristaltic pump is configured to control fluid in the fluid pipe.

In accordance with one aspect of the present disclosure, a chemical supply apparatus is provided. The chemical supply apparatus includes a protecting structure, a peristaltic pump, and a fluid pipe. The protecting structure has a first opening and a second opening. The second opening is located above the first opening. The peristaltic pump is disposed on the protecting structure. The fluid pipe is disposed in the protecting structure and the peristaltic pump. A second end of the fluid pipe is located near the second opening. The protecting structure is configured to protrude a second end of the fluid pipe by reducing the distance between the peristaltic pump and the first opening.

By applying the above configuration, the configuration is made for better. Since the protecting structure can cover an outlet of a chemical fluid container, thereby improving the protection of the fluid pipe, and an operator may transfer fluid without touching the fluid pipe.

### BRIEF DESCRIPTION OF THE DRAWINGS

Aspects of the present disclosure are readily understood from the following detailed description when read with the accompanying figures. It should be noted that various features may not be drawn to scale. That is, the dimensions of the various features may be arbitrarily increased or reduced for clarity of discussion. Embodiments of the present disclosure are described in more detail hereinafter with reference to the drawings, in which:

FIG. 1 is a perspective view of a chemical supply apparatus according to some embodiment of the present disclosure;

FIG. 2 is a side sectional view according to a cutting plane line 2 in FIG. 1;

FIGS. 3 and 4 are side sectional view of a chemical supply apparatus and a chemical fluid container according to some embodiment of the present disclosure;

FIG. 5 is a side sectional view according to a cutting plane line 5 in FIG. 1; and

FIG. 6 is a perspective view of a chemical supply apparatus according to some embodiment of the present disclosure.

### DETAILED DESCRIPTION

Common reference numerals are used throughout the drawings and the detailed description to indicate the same or similar components. Embodiments of the present disclosure will be readily understood from the following detailed description taken in conjunction with the accompanying drawings.

Spatial descriptions, such as “above,” “on,” “below,” “up,” “left,” “right,” “down,” “top,” “bottom,” “vertical,” “horizontal,” “side,” “higher,” “lower,” “upper,” “over,” “under,” and so forth, are specified with respect to a certain component or group of components, or a certain plane of a component or group of components, for the orientation of the component(s) as shown in the associated figure. It should be understood that the spatial descriptions used herein are for purposes of illustration only, and that practical implementations of the structures described herein can be spatially arranged in any orientation or manner, provided that the merits of embodiments of this disclosure are not deviated from by such arrangement.

Further, it is noted that the actual shapes of the various structures depicted as approximately rectangular may, in actual device, be curved, have rounded edges, have somewhat uneven thicknesses, etc. due to device fabrication conditions. The straight lines and right angles are used solely for convenience of representation of layers and features.

In the following description, chemical supply apparatuses, methods for operating the same, and the likes are set forth as preferred examples. It will be apparent to those skilled in the art that modifications, including additions and/or substitutions may be made without departing from the scope and spirit of the present disclosure. Specific details may be omitted so as not to obscure the present disclosure; however, the disclosure is written to enable one skilled in the art to practice the teachings herein without undue experimentation.

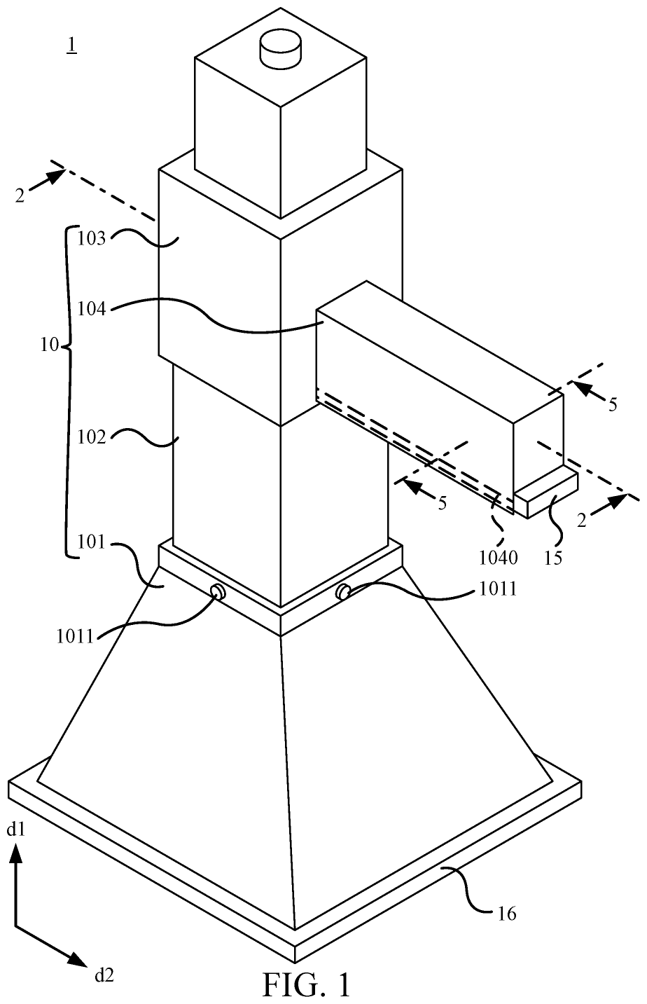

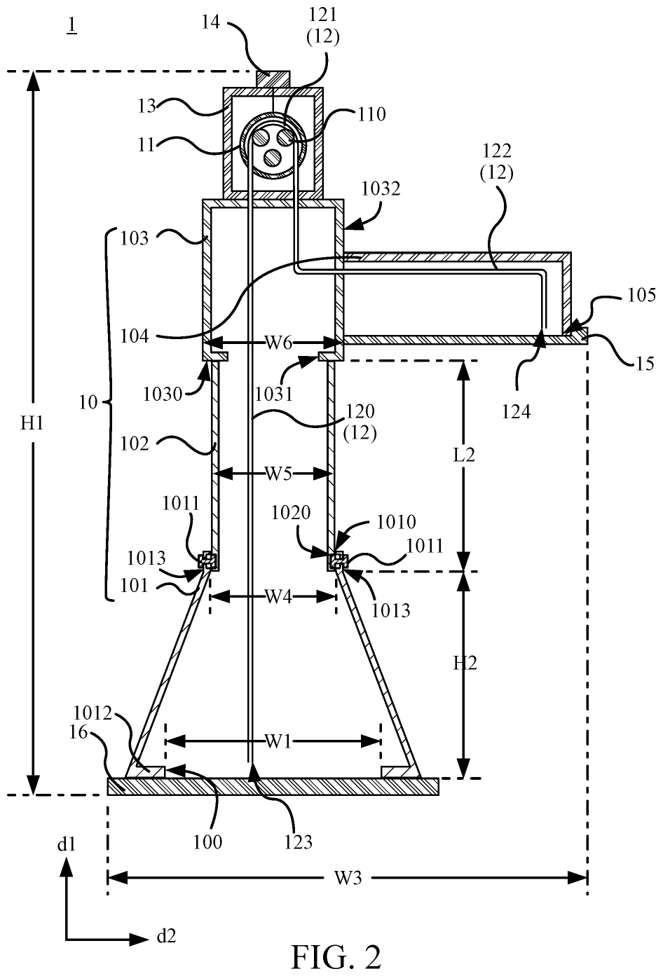

FIG. 1 is a perspective view of a chemical supply apparatus according to some embodiment of the present disclosure, and FIG. 2 is a side sectional view according to a cutting plane line 2 in FIG. 1. The chemical supply apparatus 1 includes a protecting structure 10, a peristaltic pump 11 (roller pump), and a fluid pipe 12. The peristaltic pump 11 is disposed on the protecting structure 10. The fluid pipe 12 is disposed in the protecting structure 10 and the peristaltic pump 11.

In this embodiment, the protecting structure 10 has openings 100, 105. The opening 105 is located above the opening 100, and the opening 100 and the opening 105 are facing towards the same direction. For example, the opening 100 is located at the lower part of the protecting structure 10, and the opening 100 is facing downward. The opening 105 is located at the upper part of the protecting structure 10, and the opening 105 is facing downward as well. In other words, the protecting structure 10 covers an area above the opening 100 and an area above the opening 105, and the area above the opening 100 and the area above the opening 105 are adjacent.

The peristaltic pump 11 is configured to control fluid in the fluid pipe 12. The fluid pipe 12 is flexible, and the fluid pipe 12 is fitted inside a casing of the peristaltic pump 11. The peristaltic pump 11 has a plurality of rollers 110, which compress the fluid pipe 12 as they rotate by. The peristaltic pump 11 pumps the fluid inside the fluid pipe 12. For example, the peristaltic pump 11 may have three rollers 110, and these rollers 110 compress and pump the fluid inside the fluid pipe 12.

The fluid pipe 12 connects the opening 100 and the opening 105, and the protecting structure 10 is configured to protrude the fluid pipe 12 near the opening 100. The fluid pipe 12 is configured to transfer fluid through the opening 100, the protecting structure 10, and the peristaltic pump 11, and release from the opening 105.

To be specific, the fluid pipe 12 has an end 123 and an end 124. The end 123 is configured to pass through the opening 100, and the end 124 is located near the opening 105. The protecting structure 10 is configured to protrude the end 123 of the fluid pipe 12 through the opening 100 by reducing the distance between the peristaltic pump 11 and the opening 100.

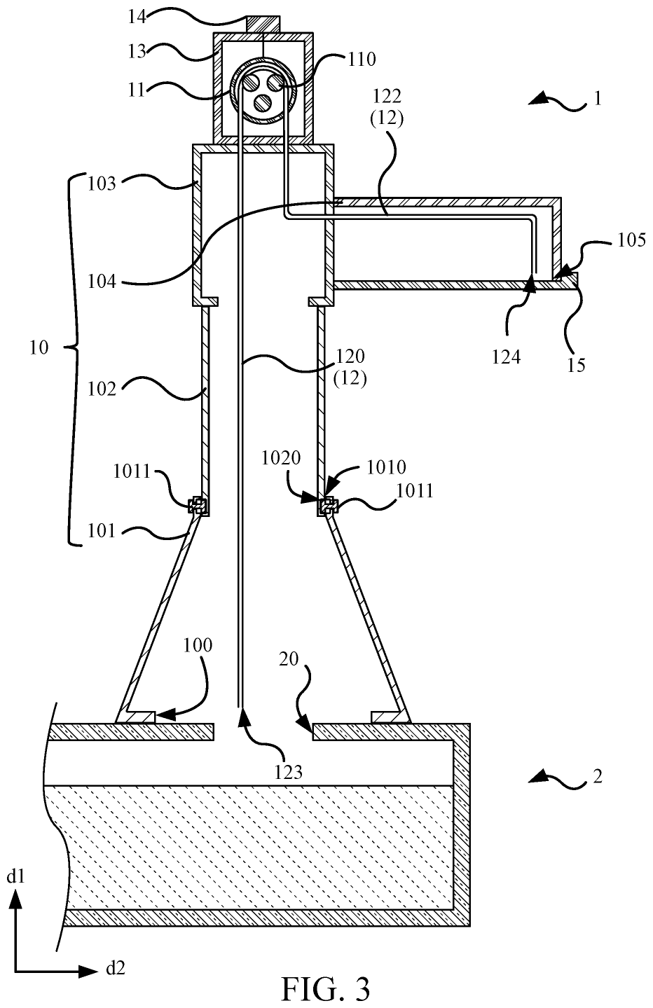

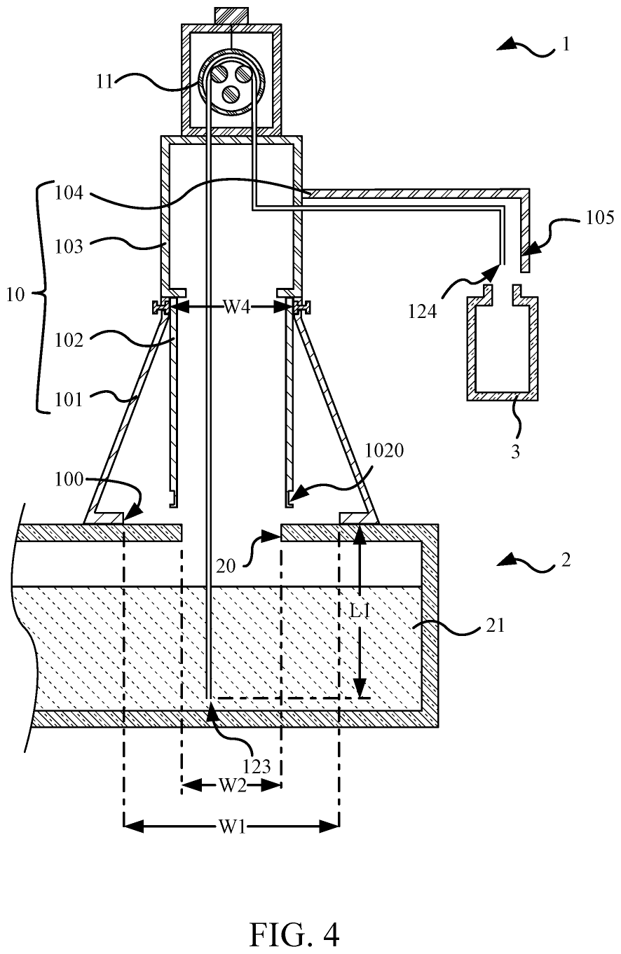

The protecting structure 10 is adapted to cover an outlet of a chemical fluid container. The fluid container can be a barrel, and the barrel contains chemical. FIGS. 3 and 4 are another side sectional figures of the chemical supply apparatus 1 and a chemical fluid container. The chemical fluid container 2 has an outlet 20, and the protecting structure 10 is adapted to cover the outlet 20 of the chemical fluid container 2.

For example, the chemical fluid container 2 contains H₂SO₄ for nitride-based semiconductor devices' wet cleaning or wet etching process. In some embodiment, the chemical fluid container 2 may contain HCL, NH₄OH, H₂O₂, or HF, and the chemical supply apparatus 1 only transfers the chemical for wet cleaning or wet etching processes for the nitride-based semiconductor devices. The nitride-based semiconductor device comprises GaN layer and AlGaN layer. The AlGaN layer is disposed on the GaN layer. The bandgap of the AlGaN layer is different from the bandgap of the GaN layer, and a 2DEG region is formed.

In this embodiment, the opening 100 has a width W1, and the outlet 20 has a width W2. The width W1 is larger than the width W2, and the protecting structure 10 can cover the whole outlet 20 through the opening 100. For example, the width W1 of the opening 100 can be 15 cm, and the width W2 of the outlet 20 can be 10 cm. In some embodiment, the width W1 of the opening 100 falls in a range from 10 cm to 20 cm, and the width W2 of the outlet 20 falls in a range from 5 cm to 15 cm.

Referring to FIGS. 2 to 4, an operation method of the chemical supply apparatus 1 comprises the following steps: disposing the chemical supply apparatus 1 on the chemical fluid container 2; extending part of the fluid pipe 12 from the protecting structure 10 of the chemical supply apparatus 1 to the inside of the chemical fluid container 2 through the outlet 20; and turn on the peristaltic pump 11 that is installed to the fluid pipe 12.

The protecting structure 10 covers the outlet 20 of the chemical fluid container 2 and the fluid pipe 12. Therefore, the protecting structure 10 can protect the outlet 20 and the fluid pipe 12. By turning on the peristaltic pump 11, the chemical supply apparatus 1 can pump the chemical fluid 21 with the fluid pipe 12 and the peristaltic pump 11. If an operator transfers the chemical fluid 21 with the chemical supply apparatus 1, the fluid pipe 12 won't be touch by the operator, and the pollution is prevented.

To be specific, the chemical supply apparatus I can transfer the chemical fluid 21 from the chemical fluid container 2 to a bottle 3, and the bottle 3 may collect the chemical fluid 21 from the end 124 of fluid pipe 12 near the opening 105. During the process, the fluid pipe 12 and the outlet 20 of the chemical fluid container 2 can be protected by the protecting structure 10, and the pollution is prevented.

Also, the chemical supply apparatus 1 can be removed from the chemical fluid container 2 easily. Therefore, the chemical supply apparatus 1 is portable. For example, the height H1 of the chemical supply apparatus 1 can be 50 cm, and the width W3 of the chemical supply apparatus 1 can be 30 cm. In some embodiments, the height H1 of the chemical supply apparatus 1 falls in a range from 40 cm to 60 cm, and the width W3 of the chemical supply apparatus 1 falls in a range from 20 cm to 40 cm. Therefore, the chemical supply apparatus 1 is portable.

In this embodiment, the protecting structure 10 includes a hollow part 101, a hollow part 102, a hollow part 103, and a hollow part 104. The hollow part 102 is coupled to the hollow part 101. The hollow part 103 is connected to the hollow part 102. The hollow part 104 is connected to the hollow part 103.

The opening 100 is located on the hollow part 101, and the opening 105 is located on the hollow part 104. To be specific, the opening 100 is formed on the bottom side of the hollow part 101, and the opening 105 is formed on the bottom side of the hollow part 104.

The peristaltic pump 11 is disposed on the hollow part 103. To be specific, the peristaltic pump 11 is located on the top of the hollow part 103, and the hollow part 102 is connected to the bottom of the hollow part 103. The hollow part 101, the hollow part 102, and the hollow part 103 are located between the opening 100 and the peristaltic pump 11. Part of the fluid pipe 12 is extended from the peristaltic pump 11 through the hollow part 103 and enter the hollow part 102.

The hollow part 102 is adapted to enter the hollow part 101. To be specific, the protecting structure 10 is configured to reduce the distance between the peristaltic pump 11 and the opening 100 by moving the hollow part 102 into the hollow part 101.

The hollow part 102 connects the hollow part 101 and the hollow part 103. When the hollow part 102 entered the hollow part 101, the hollow part 103 covers the top of the hollow part 101. By inserting the hollow part 102 into the hollow part 101, the distance between the hollow part 103 and the hollow part 101 is adjusted. When most of the part of the hollow part 102 entered the hollow part 101, the distance between the opening 100 and the peristaltic pump 11 will be shorter than the distance between the end 123 of the fluid pipe 12 and the peristaltic pump 11. Therefore, part of the fluid pipe 12 will protrude from the opening 100. In other words, the end 123 of the fluid pipe 12 protrudes from the hollow part 101. In other words, the step of extending part of the fluid pipe 12 comprises: moving the hollow part 102 into the hollow part 101.

Referring to FIG. 4, by protruding the end 123 of the fluid pipe 12, the chemical supply apparatus 1 can insert part of the fluid pipe 12 into the chemical fluid 21 inside the chemical fluid container 2, and the peristaltic pump 11 can pump the chemical fluid 21 in the fluid pipe 12 with the protection of the protecting structure 10.

By adjusting the distance between the hollow part 103 and the hollow part 101, an operator may extend the fluid pipe 12 without touching the fluid pipe 12, and the operator may transfer the chemical fluid 21 inside the chemical fluid container 2 without touching the fluid pipe 12 and the outlet 20.

In this embodiment, the hollow part 101 is shaped like frustum. Therefore, the chemical supply apparatus I can stand stably through the hollow part 101, and the hollow parts 102, 103, 104, and the peristaltic pump 11 can be held stably.

The hollow part 101 has a top opening 1010. The top opening 1010 is located at the top of the hollow part 101, and the opening 100 is located at the bottom of the hollow part 101. The top opening 1010 is located directly above the opening 100, and the fluid pipe 12 may pass through the top opening 1010 and the opening 100 without touching the hollow part 101.

The top opening 1010 is larger than a cross-section of the hollow part 102. A width W4 of the top opening 1010 is larger than a width W5 of the hollow part 102, and the hollow part 102 is configured to insert into the hollow part 101 through the top opening 1010. By inserting the hollow part 102 into the hollow part 101, the distance between the peristaltic pump 11 and the opening 100 is reduced, and part of the fluid pipe 12 will be protruded from the opening 100.

The top opening 1010 is smaller than a cross-section of the hollow part 103. The width W4 of the top opening 1010 is smaller than a width W6 of the hollow part 103, and the hollow part 103 is adapted to cover the top opening 1010. The hollow part 102 and the hollow part 103 are connected. When the hollow part 102 is inserting into the hollow part 101, the distance between the hollow part 101 and the hollow part 103 is reducing. The hollow part 102 will be stop in the hollow part 101 when the edge of the top opening 1010 touches the hollow part 103. In other words, the edge of the top opening 1010 is configured to stop the hollow part 103, and the hollow part 103 is configured to stop the hollow part 102. Therefore, the hollow part 102 and the hollow part 103 can control the length of the part of the fluid pipe 12 that extends from the opening 100.

Referring to FIG. 4, the length L1 of the part of the fluid pipe 12 that extends from the opening 100 can be 20 cm. However, the present disclosure is not limited thereto. In some embodiments, the length L1 can range from 15 cm to 25 cm, so that the fluid pipe 12 can insert into the chemical fluid 21 in the chemical fluid container 2.

Referring to FIGS. 1 and 4, in the hollow part 101, the top opening 1010 is smaller than the opening 100. The width W1 of the opening 100 is larger than the width W4 of the top opening 1010. Therefore, the opening 100 is adapted to cover most of the outlets 20 of the chemical fluid container 2, and the top opening 1010 is adapted to surround and guide the hollow part 102. Also, the chemical supply apparatus 1 can stand firmly on the chemical fluid container 2 through the hollow part 101.

Moreover, the hollow part 101 form a rim 1012 around the opening 100. The rim 1012 extends inward and horizontally. Therefore, the chemical supply apparatus 1 can stand firmly through the hollow part 101.

In this embodiment, the shape of the hollow part 102 is cuboid. In a horizontal plane, a cross section of the hollow part 102 can be a square, which has four edge that have the same length. In a vertical plane, a cross section of the hollow part 102 can be a rectangle, which has two long edges that are parallel to direction d1. The hollow part 102 is configured to move along the direction d1.

The shape of top opening 1010 of the hollow part 101 is a square as well, and the square is similar to the shape of the cross section of the hollow part 102. Therefore, the hollow part 102 can move smoothly into the hollow part 101.

The shape of the hollow part 103 is also cuboid, and the horizontal cross section of the hollow part 103 is larger than the horizontal cross section of the hollow part 102 and the area of the top opening 1010. Therefore, the hollow part 103 can be stop by edge of the top opening 1010 of the hollow part 101.

In this embodiment, the length L2 of the hollow part 102 is shorter than the height H2 of the hollow part 101. Therefore, the hollow part 101 can accommodate the hollow part 102 when the hollow part 102 is inserted into the hollow part 101.

To be specific, in the direction d1, the length L2 of the hollow part 102 is short than the height H2 of the hollow part 101. The hollow part 102 is configured to move along the direction d1 and enter the hollow part 101.

In this embodiment, the hollow part 101 has a plurality of fasteners 1011. For example, the hollow part 101 has four fasteners 1011, and the fasteners 1011 are located near the four sides of the top opening 1010.

To be specific, the fasteners 1011 pass through side surfaces 1013 of the hollow part 101 near the top opening 1010. The fasteners 1011 are dumbbell shaped buttons. Each of the fasteners 1011 has two wide pieces connected by a bar. The bar pass through the side surfaces 1013, and one of the wide pieces is located outside the hollow part 101, and the other wide piece is located inside the hollow part 101. The bar is longer than the thickness of the sidewall of the hollow part 101 near the top opening 1010. Therefore, the fasteners 1011 can move horizontally, while the sidewall is standing straight.

The fasteners 1011 are configured to fasten the hollow part 102 to the hollow part 101 while the hollow part 102 is extended from the hollow part 101. The hollow part 102 has a plurality of locking structures 1020, and the locking structures 1020 are disposed near the bottom of the hollow part 102. The locking structures 1020 are adapted to couple to the fasteners 1011.

When the bottom of the hollow part 102 is in the top opening 1010, the locking structures 1020 are aligned with the fasteners 1011 of the hollow part 101. By pushing in the fasteners 1011, every locking structures 1020 will receive part of the fastener 1011, and the fasteners 1011 are fastened to the locking structures 1020, and the position between the hollow part 101 and the hollow part 102 are locked.

When the fasteners 1011 are fastened to the locking structures 1020, most of the hollow part 102 is not in the hollow part 101, and the protecting structure 10 may cover and protect the whole fluid pipe 12. Also, operators may move the chemical supply apparatus 1 without touching the fluid pipe, and the fluid pipe may not be polluted.

In this embodiment, the hollow part 102 is connected to the bottom of the hollow part 103, and the hollow part 104 is connected to a side of the hollow part 103. The hollow part 103 is a cuboid, and the hollow part 102 is connected to the bottom surface 1030 of the hollow part 103, and the hollow part 104 is connected to the side surface 1032 of the hollow part 103. The extending direction of the fluid pipe in the protecting structure 10 is changed from direction d1 to direction d2, and operators may acquire the chemical fluid in the chemical fluid container 2 easily.

The hollow part 103 has a bottom opening 1031, which is formed on the bottom surface 1030. Therefore, the fluid pipe 12 can pass through the hollow part 103.

The hollow part 102 is extended along the direction d1, and the hollow part 104 is extended along the direction d2. The direction d1 and the direction d2 are perpendicular, and, therefore; the hollow part 104 provide a sufficient space to place a bottle 3 below it.

In this embodiment, the chemical supply apparatus 1 comprises a pump cover 13 and a pump switch 14. The pump cover 13 covers the peristaltic pump 11, and the pump switch 14 is disposed on the pump cover 13. The pump switch 14 is electrically connected to the peristaltic pump 11. The pump switch 14 controls the peristaltic pump 11.

The pump cover 13 and the peristaltic pump 11 are disposed on the top of the hollow part 103. The fluid pipe 12 extended from the peristaltic pump 11 pass through the top of the hollow part 103. The pump switch 14 is disposed on the top of the pump cover 13, so operators may control the peristaltic pump 11 easily. The peristaltic pump 11 is covered by the pump cover 13, and, therefore; the peristaltic pump 11 will not be touch during the operation. The fluid in the fluid pipe 12 can be controlled through the pump switch 14, and the fluid pipe 12 and the peristaltic pump 11 are protected by the protecting structure 10 and the pump cover 13.

In this embodiment, the fluid pipe 12 has a portion 120, a portion 121, and a portion 122. The portion 120 passes through interior of the hollow part 101, the hollow part 102, and the hollow part 103. The portion 121 is connected to the portion 120, and the portion 121 is disposed in the peristaltic pump 11. The portion 121 connects the portion 120 and the portion 122, and the portion 122 passes through the interior of the hollow part 103 and the hollow part 104. Therefore, the peristaltic pump 11 can pump the fluid from portion 120 to portion 122 through portion 121.

The protecting structure 10 and the peristaltic pump 11 enclose the fluid pipe 12, and no other opening are formed on the protecting structure 10 or the peristaltic pump 11. Therefore, the protecting structure 10 and the peristaltic pump 11 can well protect the fluid pipe 12, and pollution can be prevented during operation.

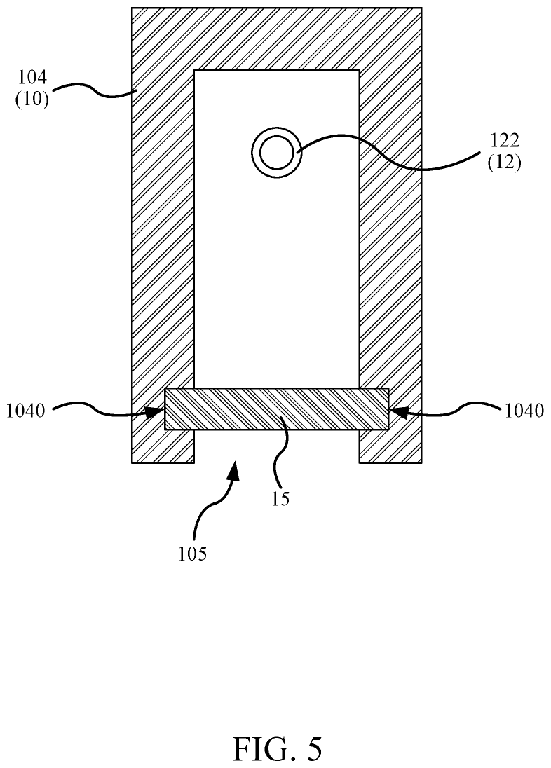

In this embodiment, the chemical supply apparatus 1 includes a cover 15. FIG. 5 is a side sectional view according to cutting plane line 5 in FIG. 1. The hollow part 104 has a pair of guiding grooves 1040. The guiding grooves 1040 are formed on the inner wall of the opening 105. The cover 15 is configured to slide along the guiding grooves 1040 and cover the opening 105.

Therefore, when the chemical supply apparatus 1 is not supplying chemical fluid, the portion 122 of the fluid pipe 12 is enclosed by the cover 15. The cover 15 can provide further protection.

Referring to FIG. 1, the hollow part 102 is configured to move along direction d1, and the guiding grooves 1040 are extended along the direction d2. The direction d1 is perpendicular to the direction d2. Therefore, the cover 15 may well cover the opening 105, and the cover 15 can be removed easily.

By covering the opening 105 with the cover 15, the cover 15 may protect the portion 122 of the fluid pipe 12 in storage or during transportation. Before turning on the peristaltic pump 11, the operation method of the chemical supply apparatus 1 includes: removing the cover 15 covering the opening 105. Referring to FIG. 4, the end 124 of the fluid pipe 12 is uncovered, and the fluid may be provided through the fluid pipe 12.

Referring to FIG. 2, the chemical supply apparatus 1 includes a cover 16 covering the opening 100. With the covers 15, 16, the protecting structure 10 may enclosed the fluid pipe 12 completely. The cover 16 covers the opening 100, and the end 123 of the fluid pipe 12 is protected.

By covering the opening 100 with the cover 16, the cover 16 may protect the portion 120 of the fluid pipe 12 in storage or during transportation. Before disposing the chemical supply apparatus 1 on the chemical fluid container 2, the operation method of the chemical supply apparatus 1 includes: removing the cover 16 covering the opening 100.

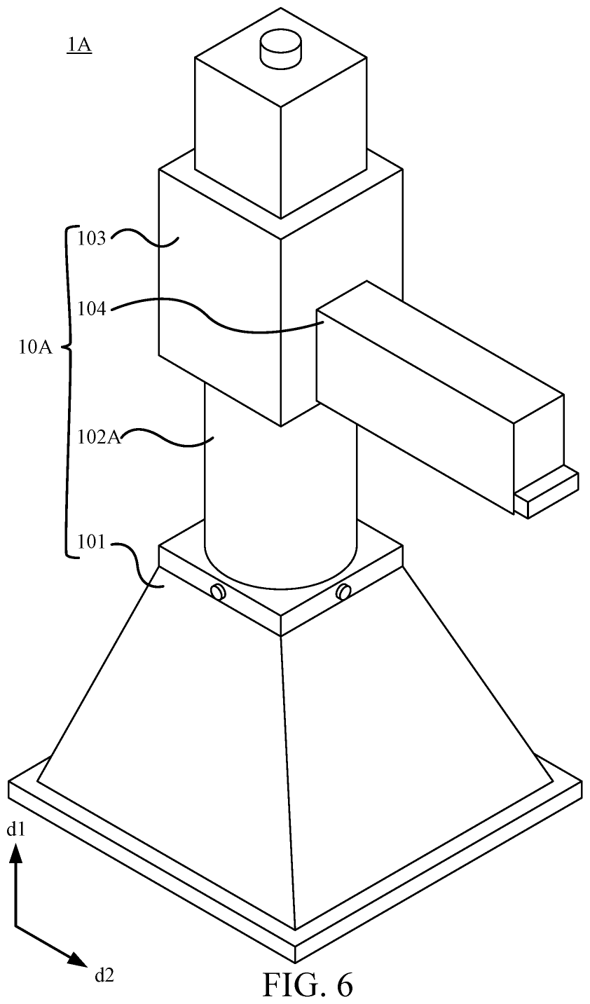

FIG. 6 is a perspective view of a chemical supply apparatus according to some embodiment of the present disclosure. The chemical supply apparatus 1A is similar to the chemical supply apparatus 1 above, and description about the same components will not be repeated herein. In this embodiment, the protecting structure 10A has a hollow part 101, a hollow part 102A, a hollow part 103, and a hollow part 104. The hollow part 102A is a cylinder-like structure, which is different from the hollow part 102 of the chemical supply apparatus 1. To be specific, a horizontal cross-section of the hollow part 102A is a circle. Therefore, the hollow part 102A can move into the hollow part 101 smoothly.

The embodiments were chosen and described in order to best explain the principles of the invention and its practical application, thereby enabling others skilled in the art to understand the invention for various embodiments and with various modifications that are suited to the particular use contemplated.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. The term “substantially coplanar” can refer to two surfaces within micrometers of lying along a same plane, such as within 40 μm, within 30 μm, within 20 μm, within 10 μm, or within 1 μm of lying along the same plane.

As used herein, the singular terms “a,” “an,” and “the” may include plural referents unless the context clearly dictates otherwise. In the description of some embodiments, a component provided “on” or “over” another component can encompass cases where the former component is directly on (e.g., in physical contact with) the latter component, as well as cases where one or more intervening components are located between the former component and the latter component.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. Further, it is understood that actual devices and layers may deviate from the rectangular layer depictions of the FIGS. and may include angles surfaces or edges, rounded corners, etc. due to manufacturing processes such as conformal deposition, etching, etc. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

1. A chemical supply apparatus comprising:
a protecting structure having:
a first opening; and
a second opening located above the first opening;
a peristaltic pump disposed on the protecting structure; and
a fluid pipe disposed in the protecting structure and the peristaltic pump,
wherein the first opening and the second opening are facing towards the same direction,
wherein the fluid pipe connects the first opening and the second opening,
wherein the peristaltic pump is configured to control fluid in the fluid pipe,
wherein the protecting structure is adapted to cover an outlet of a chemical fluid container.

2. The chemical supply apparatus of claim 1, wherein the protecting structure comprises:
a first hollow part;
a second hollow part coupled to the first hollow part;
a third hollow part connected to the second hollow part; and
a fourth hollow part connected to the third hollow part,
wherein the first opening is located on the first hollow part, and the second opening is located on the fourth hollow part;
wherein the second hollow part is adapted to enter the first hollow part,
wherein, when the second hollow part entered the first hollow part, the third hollow part covers the top of the first hollow part, and an end of the fluid pipe protrudes from the first hollow part.

3. The chemical supply apparatus of claim 2, wherein the first hollow part is shaped like frustum.

4. The chemical supply apparatus of claim 2, wherein the first hollow part has a first top opening, and the first opening is located at the bottom of the first hollow part, and the first top opening is larger than a cross-section of the second hollow part, and the first top opening is smaller than a cross-section of the third hollow part.

5. The chemical supply apparatus of claim 4, wherein the first top opening is smaller than the first opening.

6. The chemical supply apparatus of claim 4, wherein the first hollow part has a plurality of fasteners, and the fasteners pass through side surfaces of the first hollow part near the first top opening, and the second hollow part has a plurality of locking structures disposed near the bottom of the second hollow part, and the locking structures are adapted to couple to the fasteners.

7. The chemical supply apparatus of claim 2, wherein shape of the second hollow part is cuboid.

8. The chemical supply apparatus of claim 2, wherein length of the second hollow part is shorter than height of the first hollow part.

9. The chemical supply apparatus of claim 2, wherein the second hollow part is connected to the bottom of the third hollow part, and the fourth hollow part is connected to a side of the third hollow part.

10. The chemical supply apparatus of claim 2, further comprising:
a pump cover covering the peristaltic pump; and
a pump switch being disposed on the pump cover,
wherein the pump switch is electrically connected to the peristaltic pump.

11. The chemical supply apparatus of claim 2, wherein the second hollow part extends along a first direction, and the fourth hollow part extends along a second direction, and the first direction is perpendicular to the second direction.

12. The chemical supply apparatus of claim 2, wherein the fluid pipe comprises:
a first portion passing through interior of the first hollow part, the second hollow part, and the third hollow part;
a second portion connected to the first portion and being disposed in the peristaltic pump; and
a third portion passing through interior of the third hollow part, and the fourth hollow part.

13. The chemical supply apparatus of claim 2 further comprising a second cover, wherein the fourth hollow part has a pair of guiding grooves formed on the inner wall of the second opening, and the second cover is configured to slide along the guiding grooves and cover the second opening.

14. The chemical supply apparatus of claim 13, wherein the second hollow part is configured to move along a first direction, and the guiding grooves are extended along a second direction, and the first direction is perpendicular to the second direction.

15. The chemical supply apparatus of claim 1 further comprising a first cover covering the first opening.

16. A operation method of a chemical supply apparatus, comprising:
disposing the chemical supply apparatus on a chemical fluid container, wherein the chemical supply apparatus covers an outlet of the chemical fluid container;
extending part of a fluid pipe from a protecting structure of the chemical supply apparatus to the inside of the chemical fluid container through the outlet; and
turn on a peristaltic pump being installed to the fluid pipe,
wherein the chemical supply apparatus comprises the protecting structure, the fluid pipe, and the peristaltic pump, and the peristaltic pump is disposed on the protecting structure, and the fluid pipe is disposed in the protecting structure and the peristaltic pump,
wherein a second opening of the protecting structure is located above a first opening of the protecting structure, and the first opening and the second opening are facing towards the same direction,
wherein the fluid pipe connects the first opening and the second opening,
wherein the peristaltic pump is configured to control fluid in the fluid pipe.

17. The operation method of claim 16, wherein the protecting structure comprises:
a first hollow part;
a second hollow part coupled to the first hollow part;
a third hollow part connected to the second hollow part; and
a fourth hollow part connected to the third hollow part,
wherein the first opening is located on the first hollow part, and the second opening is located on the fourth hollow part, and the step of extending part of the fluid pipe comprises:
moving the second hollow part into the first hollow part.

18. The operation method of claim 17, wherein the third hollow part covers the top of the first hollow part when the second hollow part entered the first hollow part.

19. The operation method of claim 16, before disposing the chemical supply apparatus on the chemical fluid container, further comprising:
removing a first cover covering the first opening.

20. The operation method of claim 16, before turning on the peristaltic pump, further comprising:
removing a second cover covering the second opening.

21-25. (canceled)
